(19) United States
(12) Patent Application Publication
(10) Pub. No.: US 2009/0214993 A1
(43) Pub. Date: Aug. 27, 2009

(54) SYSTEM USING OVER FIRE ZONE SENSORS AND DATA ANALYSIS

(76) Inventors: Timothy A. Fuller, North Canton, OH (US); Thomas J. Flynn, North Canton, OH (US); Paul Li, Canton, OH (US); Ralph T. Bailey, Uniontown, OH (US)

Correspondence Address: BABCOCK & WILCOX POWER GENERATION GROUP, INC., PATENT DEPARTMENT, 20 SOUTH VAN BUREN AVENUE, BARBERTON, OH, 44203, US

(21) Appl. No.: 12/036,639

(22) Filed: Feb. 25, 2008

(51) Int. Cl. G05B 21/00; G05B 99/00

(52) U.S. Cl. 431/13; 700/274

(57) ABSTRACT

A system for analyzing the quality of combustion in the vicinity of the over fire zone of a combustion system includes at least one lens assembly mounted to a wall of the combustion system in the vicinity of the over fire zone. One or more photo-detectors are used to measure the intensity of light emitted in the over fire zone. A data acquisition system is connected to the photo-detector assembly via a communication link and includes an analog-to-digital converter and data buffering device for converting the light signals to digital signals. A computer analyzes the digital signals with linear and nonlinear signal analysis techniques.

### FIELD AND BACKGROUND OF INVENTION

The present invention relates generally to the field of combustion and in particular to a new and useful diagnostic system for monitoring combustion in the over fire air (OFA) zone of a combustion system.

Industry attention has increasingly become focused on innovative methods to help control emissions from coal fired steam generators. Advanced low-NOₓ burners with staged air systems have been developed that can achieve greatly reduced emissions of NOₓ while controlling other constituents such as CO, fly ash loss on ignition (LOI) etc., resulting in overall improved operations. In most instances, these low NOₓ systems are supplied with guaranteed performance that is based on the normal practices of adjusting equipment by parametric tuning during the start-up and commissioning process.

As burner technology has advanced, the ability to stage the combustion and introduce air into the OFA zone has become increasingly important. OFA is controlled to balance minimum achievable NOₓ with acceptable CO. As burners are operated more sub stoichiometrically to achieve lower NOₓ emissions, pockets or plumes of uncombustable CO gas pass into the OFA zone. OFA must be distributed effectively to reduce CO emissions. Real-time OFA zone data, if proven to be predictable versus the state of the combustion process, would provide for better and continuous control of this important zone. Thus, the addition of advanced sensors to provide real-time measurements and feedback for the combustion process in the upper furnace (OFA zone) of the boiler is needed.

Diagnostic systems for fluidized beds have been developed. These diagnostic systems are based on concepts from the theory of nonlinear dynamics, also known as chaos theory. Chaos theory is employed to monitor and control the interaction between particulates and gases in the turbulent flow of a fluidized bed, thus improving its performance and reducing emissions of gaseous pollutants.

Diagnostic systems are also available for low-NOₓ burners. These systems utilize signals from existing optical flame scanners to diagnose poor operation in individual burners that contributes to excessive emissions and low efficiency. By continuously monitoring the status of all burners, it is possible to optimize overall furnace performance in spite of load changes, fuel quality variations and equipment deterioration. The main hardware components of a monitoring system are a central data acquisition system for collecting flame scanner signals and a computer for signal processing and display. A graphical user interface and a diagnostics module for processing the scanner signals are also included. The system uses mathematical tools for identifying flame patterns and diagnosing combustion problems.

U.S. Pat. No. 6,389,330 discloses combustion diagnostic technology for the burner flame zone as well as the postflame combustion zone in the proximity of the over-fire air ports. In particular, the diagnostic technology provided in U.S. Pat. No. 6,389,330 includes sensors and signal analysis algorithms. The sensors are sensitive to radiation in different portions of the electromagnetic spectrum. The signal analysis employs linear analysis techniques. Low-frequency fluctuations in the radiation signal are shown to be sensitive to changes in the post-flame combustion conditions. The analysis essentially determines the number of positive and negative peaks beyond predetermined threshold values to identify instabilities and maldistributions. The analysis techniques are not based on principles of chaos theory. The results of the signal analysis have been correlated to important performance parameters such as CO and NOₓ. Other signal processing systems for analyzing operation of a combustion burner are known from U.S. Pat. No. 5,798,946.

Linear analysis techniques alone are insufficient to discriminate important differences in combustion stability. Thus, there is also a need in the art for signal analysis techniques that are likely to enhance the information that may be generated from sensors located in the vicinity of the over fire air ports.

### SUMMARY OF INVENTION

It is an object of the present invention to increase unit performance with enhanced monitoring and control of the OFA.

It is a further object of the present invention to provide an apparatus for acquiring a signal representative of the combustion conditions in the vicinity of the OFA ports.

It is yet another object of the present invention to provide a system and method for analyzing the signal to determine the quality of combustion in the vicinity of the OFA ports.

Accordingly, a system for analyzing the quality of combustion in the vicinity of the over fire zone of a combustion system is provided. The system comprises at least one lens assembly mounted to a wall of the combustion system in the vicinity of the over fire zone. One or more photo-detectors are used to produce an analog signal that is proportional to the intensity of light emitted in the OFA zone. The photo-detector signals are transmitted to a data acquisition system via a communication link. The data acquisition system comprises an analog-to-digital converter and data buffering device for converting the analog signals to digital signals. Means for analyzing the digital signals, such as a computer is provided. The computer stores data, provides the analysis programs and provides a graphical user interface.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a schematic representation of a system of the present invention;

FIG. 2 is a top plan view of the lens assembly of the present invention;

FIG. 3 is a front view of the lens assembly of the present invention;

FIG. 4 is a side view of the lens assembly of the present invention; and

FIG. 5 is a schematic representation of a system having lens assemblies at alternate locations.

### DESCRIPTION OF THE PREFERRED EMBODIMENTS

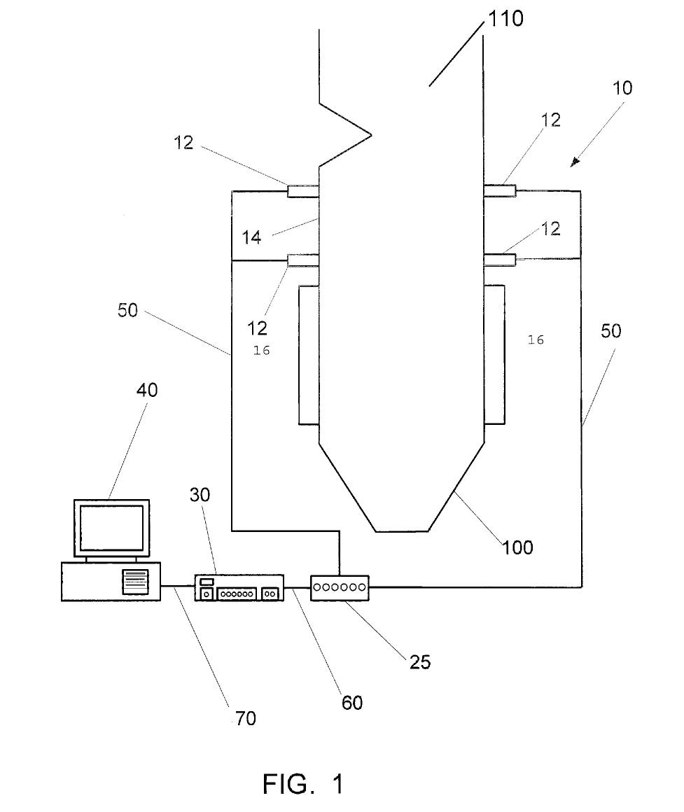

FIG. 1 shows a system 10 for acquiring a signal representative of the combustion conditions in the vicinity of an OFA port as well as for analyzing the signal to determine the quality of combustion in the vicinity of an OFA port. System 10 comprises a lens assembly (or assemblies) 12 installed in the upper furnace combustion zone 110 of the boiler 100 in the vicinity of the OFA ports 16, a photo-detector assembly 25, a data acquisition system 30, and a computer 40. The lens assembly 12 is connected to the individual photo-detector sensors housed in assembly 25 via a first communication link 50 such as fiber optic cabling. The photo-detectors in assembly 25 produce analog signals which are sent to the data acquisition system 30 via a second communication link, such as a ribbon cable 60. The data acquisition system 30 comprises an analog-to-digital converter and data buffering device. At least one sensor is associated with each lens assembly 12. Each sensor acquires a light signal from its respective lens assembly 12. The analog-to-digital converter and data buffering device converts the light signal to a digital signal for analysis by computer algorithms as described below. A third communication link, such as an ethernet cable 70, is used to connect the data acquisition system to a computer 40 in the control room. The communication link is preferably an ethernet cable, but may also include wireless connection via wireless transmitters.

Two types of photo-detectors, sensitive to different wavelength ranges, are used to measure the intensity of light emitted in the post-combustion over-fire zone. Silicon photo-detectors are sensitive to light extending from ultra-violet (0.2 micrometers) to near infra-red (1.0 micrometers). Germanium photo-detectors are sensitive to light only in the near infra-red region extending from 1.0 to 1.6 micrometers. The time varying signal from these photo-detectors can then be measured and analyzed. Although silicon and germanium photo-detectors are preferably used in the present invention, photo-detectors may be constructed of other materials which are also suitable. Since photo-detectors may be constructed of different materials, or may be sensitive to different wavelengths of light, different types of photo-detectors may be acceptable. The photo-detectors may be located remotely from the lens assembly in a dedicated assembly 25, or closely coupled to the lens 12 in the vicinity of the OFA ports.

In addition, light originating from a single measurement location can be split and simultaneously measured with two photo-detectors, wherein each detector measures a different range of the light spectrum, thus providing a measurement of light intensity in two different wavelength ranges. The ratio of these two simultaneous signals from the two photo-detectors (i.e., two wavelength ranges) can be used to infer temperature using the well known technique of two-color pyrometry.

After the light signals are converted to digital signals by the analog-to-digital converter and data buffering device, traditional linear analysis techniques in the form of algorithms are used to analyze the signals including standard statistics, such as average, root means square (RMS), skewness and kurtosis, power spectrum analysis, and cluster analysis. In addition to the linear analysis techniques, nonlinear analysis techniques such as correlation dimension, entropy, temporal irreversibility, symbol sequence analysis, and mutual information are also employed.

A unique novel feature of the present invention is the combination of signal average and RMS provides a measure of combustion intensity associated with the burning of CO gas. The average or DC component of the signal is a measure of the sustained presence and concentration of CO in the vicinity of an OFA port. The RMS or AC component (fluctuating component) of the signal provides an indication of the temporal fluctuations in the CO concentration. Both are critical to assessing and adjusting the amount of OFA that must be routed to the OFA port to effectively burn the residual CO in the flue gas. A large average value indicates the presence of a plume of CO gas and the need for more over fire air. It also suggests the burners below the OFA port may need to be adjusted to reduce the concentration of CO in the vicinity of the specific OFA port. A low average value coupled with a large RMS value indicates alternating patches of CO-rich and CO-lean gas passing in the vicinity of the OFA port. This characteristic in the signal suggests a misdistribution in the aggregate mixing of gases from many burners or a fluctuation in emissions from a single burner, or group of burners due to variations in fuel or air flows to the affected burners.

Temporal irreversibility in particular is an analysis technique that can discriminate between combustion events associated with a specific OFA port from combustion events occurring across the furnace at OFA ports on the opposite wall. Nonlinear analysis techniques coupled with linear analysis techniques have been shown to provide more information about the nature of combustion instabilities and quality than linear techniques alone. Also, the coupling of nonlinear techniques with linear techniques also minimizes the likelihood that misinformation about the quality of combustion will be generated.

The results of the analysis techniques are evaluated against known results that correspond to good combustion. The results of each sensor on one wall are compared to each other to assess uniformity of combustion for a group of OFA ports. For example, signals indicating intense combustion at an individual OFA port when analyzed would alert the operator to direct more air to that specific port or to investigate the column of burners below that port for potential combustion problems on the burners themselves.

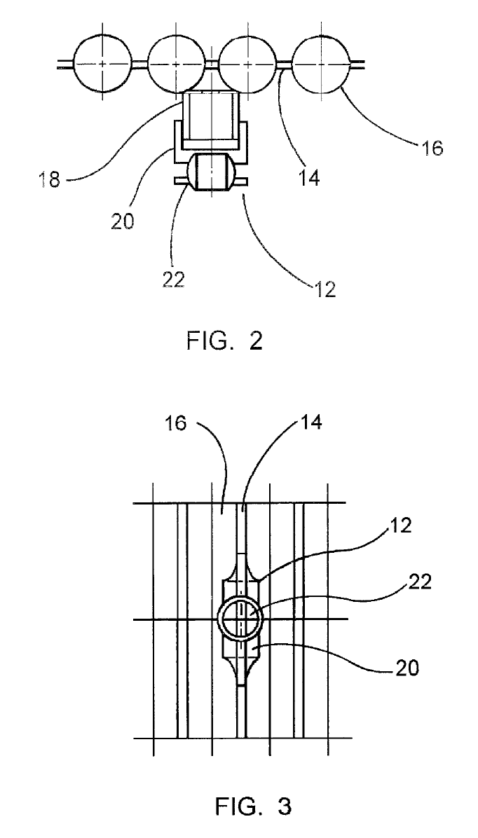

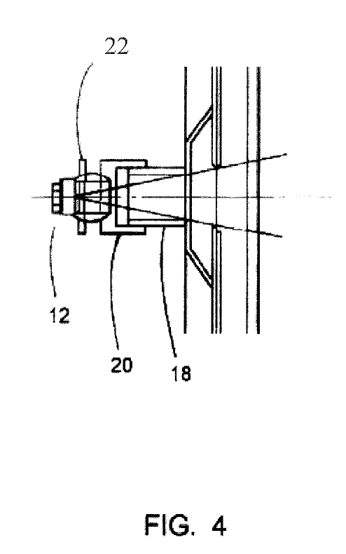

FIGS. 2-4 show a lens assembly 12. Insulation and lagging are removed in the vicinity of the intended lens assembly location to expose the membrane wall 14. A 2″ slot is cut in the membrane of the wall 14 between the crowns of adjacent tubes 16. A scanner mounting fixture 18 is mounted on the membrane wall and welded to the membrane wall 14 to form a gas tight seal. An articulating scanner mounting 20 is attached to the scanner mounting fixture 18. The articulating scanner mounting 20 provides flexibility to optimize the sighting of the lens assembly to provide the maximum information about the combustion quality in the vicinity of the OFA ports. A drive mechanism can be attached to the articulating scanner mounting 20 to allow it to be adjusted to the optimum position as load on the boiler 100 changes. Insulation and lagging is reinstalled around the completed assembly. Lenses 22 are attached to the articulating scanner mountings 20.

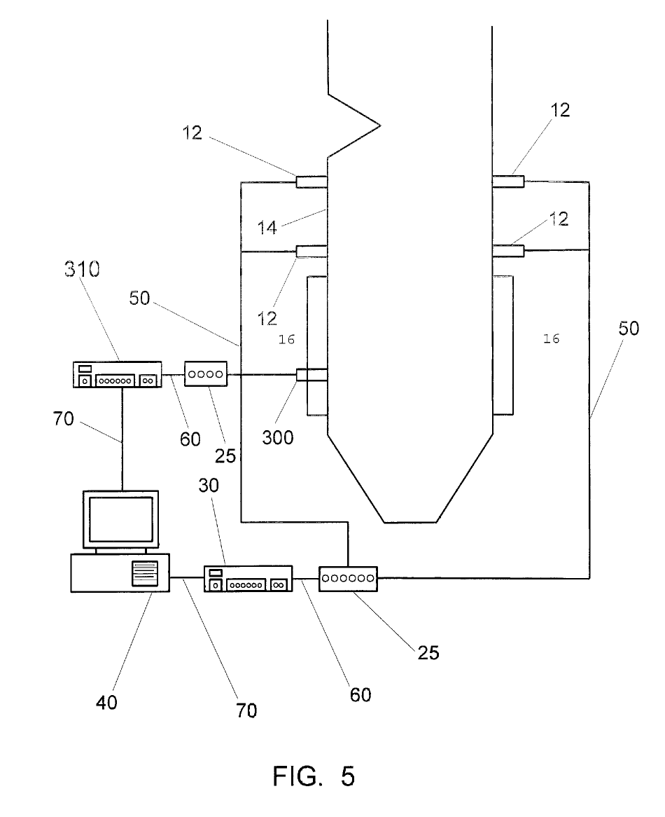

The results of the analysis of the quality of combustion in the vicinity of the OFA port can be combined with the results of the analysis of the quality of combustion at the burners or elsewhere in the combustion system to guide tuning of the entire combustion system. As shown in FIG. 5, another lens assembly 300 is provided at another location on the boiler, such as at the vicinity of a burner, and is connected to a second data acquisition system 310 which is also connected to computer 40 in the control room. Thus, computer 40 can therefore analyze multiple locations in the combustion system.

While a specific embodiment of the invention has been shown and described in detail to illustrate the application of the principles of the invention, it will be understood that the invention may be embodied otherwise without departing from such principles.

We claim:

1. A system for analyzing combustion quality in a vicinity of an over fire zone of a combustion system comprising:
at least one lens assembly mounted to a wall of the combustion system in the vicinity of the over fire zone;
a photo-detector assembly arranged to measure the intensity of light emitted in the over fire zone;
a first communication link between the lens assembly and a photo detector assembly,
a data acquisition system connected to the photo-detector assembly via a second communication link, comprising an analog-to-digital converter and data buffering device for converting said light signals to digital signals; and
a means for analyzing the digital signals, connected to said data acquisition system via a third communication link.

2. A system according to claim 1, wherein the lens assembly comprises a scanner mounting fixture mounted on a wall of said combustion system, an articulating scanner mounting attached to the scanner mounting fixture, and a lens attached to the articulating scanner mounting.

3. A system according to claim 2, further comprising a drive mechanism attached to the articulating scanner mounting for adjustment of the position of said articulating scanner mounting.

4. A system according to claim 1, wherein the lens assembly is mounted in a slot in the wall between crowns of adjacent tubes.

5. A system according to claim 1, wherein Silicon photo-detectors are used to measure the intensity of light emitted in the over-fire zone.

6. A system according to claim 1, wherein Germanium photo-detectors are used to measure the intensity of light emitted in the over-fire zone.

7. A system according to claim 1, wherein two photo-detector assemblies are simultaneously used to detect two light signals split from a light signal originating from a single measurement location.

8. A system according to claim 7, wherein said two photo-detector assemblies are Silicon and Germanium.

9. A system according to claim 1, wherein a plurality of lens assemblies are mounted on opposite walls of said combustion system.

10. A system according to claim 1, wherein said first communication link between at least one lens assembly and said photo-detector assembly is fiber optic.

11. A system according to claim 1, wherein said second communication link between said data acquisition system and said photo-detector assembly is a ribbon cable.

12. A system according to claim 1, wherein said third communication link is a ethernet cable.

13. A system according to claim 1, wherein said third communication link is a wireless communications connection.

14. A system according to claim 1, wherein said means for analyzing is a computer.

15. A system according to claim 1, wherein said means for analyzing employs a combination of linear and non-linear analysis techniques as algorithms to analyze said digital signals.

16. A system according to claim 15, wherein said linear analysis techniques include standard statistics selected from the group consisting of average, root means square, skewness, kurtosis, power spectrum analysis, and cluster analysis.

17. A system according to claim 15, wherein said nonlinear analysis techniques are selected from the group consisting of correlation dimension, entropy, temporal irreversibility, symbol sequence analysis, and mutual information.

18. A system according to claim 1, further comprising at least one additional lens assembly arranged at alternate location of said combustion system, a second data acquisition system connected to said additional lens assembly via a fourth communication link and to said means for analyzing via a fifth communication link.

19. A method for analyzing the quality of combustion in a vicinity of the over fire zone of a combustion system comprising the steps of:
receiving a signal representative of combustion conditions in the vicinity of the over fire zone; and
analyzing said signal to determine combustion intensity and quality in the vicinity of the over fire zone.

20. A method according to claim 19, wherein the signal is analyzed by a combination of linear and non-linear analysis techniques as algorithms.

21. A system according to claim 20, wherein said linear analysis techniques include standard statistics selected from the group consisting of average, root mean square, skewness, kurtosis, power spectrum analysis, and cluster analysis.

22. A system according to claim 20, wherein said nonlinear analysis techniques are selected from the group consisting of correlation dimension, entropy, temporal irreversibility, symbol sequence analysis, and mutual information.
